(19) United States
(12) Patent Application Publication
(10) Pub. No.: US 2026/0175141 A1
(43) Pub. Date: Jun. 25, 2026

(54) METHOD AND SYSTEM FOR PURIFYING CONTAMINATED OIL

(71) Applicants: SKF RECONDOIL AB, Stockholm (SE); SKF MFR TECHNOLOGY AB, Stockholm (SE)

(72) Inventors: Lasse HURNASTI, Huddinge (SE); Anders KRONANDER, Stockholm (SE); Christian NATHANIEL, Stockholm (SE)

(21) Appl. No.: 19/127,439

(22) PCT Filed: Nov. 14, 2022
(86) PCT No.: PCT/EP2022/081806

§ 371 Date: May 6, 2025

(51) Int. Cl. B01D 17/04; B01D 17/02; B04B 5/00; B04B 5/12; C02F 1/24; C02F 101/32

(52) U.S. Cl. CPC B01D 17/045; B01D 17/0214; B04B 5/005; B04B 5/12; C02F 1/24; C02F 2101/32

(57) ABSTRACT

In a method, system and computer program for purifying an oil containing contaminants, a two-phase mixture of the oil and a separation aid is introduced through a hermetic inlet into a separation chamber of a rotating separator bowl of a centrifugal separator, such that no air is introduced into the two-phase mixture while it is being fed into the centrifugal separator. The separation aid has a density higher than the density of the oil. In the separation chamber, separation aid having contaminants absorbed and/or adsorbed therein is separated from the oil. Thereafter, purified oil is discharged from a light phase outlet of the separation chamber and separation aid having contaminants absorbed and/or adsorbed therein is discharged from a heavy phase outlet of the separation chamber.

### CROSS-REFERENCE

This application is the U.S. National Stage of International Application No. PCT/EP2022/081806 filed on Nov. 14, 2022.

### TECHNICAL FIELD OF THE INVENTION

The present invention generally relates to a method and system for purifying contaminated oil. More particularly, the present invention relates to a method and system for purifying oil using a separation aid and a centrifugal separator having a hermetic inlet.

### BACKGROUND OF THE INVENTION

Purification of contaminated oils, such as for example slop oil, waste oil, slurry oil, crude oil, industrial oil, petroleum products or bio-oils, is important for the possibility of using/reusing oils and therefore is an important factor for the environmental future and the limited natural resources of oils. Purification of contaminated oil such as slop oil and waste oil is problematic in many ways. For example, contaminated oil can comprise oil, water, particles and an emulsion phase. The particles can stabilize the emulsion phase and complicate a purification process. Purification of industrial emulsions comprising water and oil, such as for example cutting fluids, is also an important desired goal to achieve.

A separation aid may be used for purifying contaminated oil. The separation aid is mixed with the contaminated oil whereby the separation aid, by chemical interactions, absorbs and/or adsorbs contaminating solids or dissolved impurities in the contaminated oil. The separation aid, which due to its general polar nature is substantially insoluble in the oil to be purified, forms a two-phase system with the oil and can be separated from the oil for example by sedimentation. Such sedimentation is however somewhat limited in that it requires significant time for the separation aid, typically present as small droplet in the oils, to sediment and allow the now clean oil to be retrieved. In order to increase the handling (processing) capacity, the sedimentation tank must be enlarged and/or intermediate holding tanks are required to hold the mixture of contaminated oil and separation aid prior to sedimentation.

On the other hand, centrifugal separators have been used to separate oil from water. A centrifugal separator provides a higher capacity for treating contaminated oil. EP 1570036 B1, inter alia, discloses a method of purifying oil in a centrifugal separator, wherein a separation aid is dispersed in the oil.

Despite these various approaches, there still exists a need for further improved methods and systems for purifying contaminated oil.

### SUMMARY OF THE INVENTION

It is therefore one non-limiting object of the present teachings to disclose techniques for increasing the speed and/or efficiency of a method for purifying contaminated oil.

It is another non-limiting object of the present teachings to disclose techniques for improving a system for carrying out such a method.

It is another non-limiting of the present teachings to provide a computer program product containing instructions which, when carried out by a processor of a control unit of the system. causes the system to perform the method.

Thus, in one non-limiting aspect of the present teachings, a method for purifying an oil containing contaminants comprises:
i. introducing a mixture of the oil and a separation aid through a hermetic inlet into a separation chamber of a rotating separator bowl of a centrifugal separator, the separation aid having a density higher than that of the oil,
ii. separating the separation aid and contaminants absorbed and/or adsorbed therein from the oil in the separation chamber,
iii. discharging oil from a light phase outlet of the separation chamber, and
iv. discharging separation aid and contaminants absorbed and/or adsorbed therein from a heavy phase outlet of the separation chamber.

In another non-limiting aspect of the present teachings, a system for purifying an oil comprising contaminants comprises:
a mixer for mixing an oil comprising contaminants with a separation aid to produce a mixture of the oil and the separation aid, and
a centrifugal separator having a separator bowl comprising (defining) a separation chamber for separating the separation aid and contaminants absorbed and/or adsorbed therein from the oil, the centrifugal separator further comprising a light phase outlet and a heavy phase outlet, wherein the centrifugal separator further comprises a hermetic inlet configured to introduce the mixture of the oil and the separation aid into the separation chamber.

The present teachings are thus based on the finding, by the present inventors, that the efficiency of separating a dispersion of contaminated oil in a centrifugal separator is hampered by the break up and subsequent re-formation of smaller droplets of separation aid during the separation. In other words, the present inventors have found that, when a mixture of contaminated oil and separation aid enters the centrifugal separator, the separation aid phase, which is typically present as droplets in the oil, is further broken up into even smaller droplets that are so small that they cannot be efficiently separated from the oil by the centrifugal separator. Specifically, the smaller the droplet, the slower it moves through the oil. This can to some extent be countered by lowering the rotational speed (rpm) of the centrifugal separator, but this decreases the efficiency (speed) of the separation. In addition to droplet size and flow rate, the efficiency of the separation also depends on the type of separator and the viscosity of the oil. Together, these limitations may limit the usefulness of a centrifugal separator for purifying oil.

Surprisingly, as disclosed above, the method and system according to the above-mentioned non-limiting aspects of the present teachings employ a centrifugal separator having a hermetic inlet. The hermetic inlet, although more complicated than a standard inlet for a centrifugal separator, prevents the break-up of droplets of separation aid due to the application of a lower shear force which is achieved due to the absence of atmospheric gases being entrained by (in) the mixture of oil and separation aid entering the centrifugal separator. Specifically, in traditional centrifuge inlets, a rotating level is created in the inlet zone or inlet space, i.e., in the oil-air/gas interface. Looking from the center of rotation in the inlet, the rotating level (oil-air/gas interface) radius creates shear forces. A smaller radius results in less shear force, whereas a larger radius increases the shear force. Depending on the size of a disc stack centrifuge, the inlet level changes due to the design.

In a hermetic inlet, the inlet zone is sealed off, so that no atmospheric gases are mixed into the mixture of oil and separation aid. As a result, the inlet space can (will) be completely filled. Consequently, there is no rotating liquid level that would create low shear forces when non-rotating liquid is accelerated to the same rotational speed as the centrifuge bowl (separator bowl). Thus, because the mixture of oil and separation aid can be (is) introduced into the centrifugal separator with no, or only limited, further break-up of droplets of the separation aid, the centrifugal separator can more efficiently (quickly) separate the separation aid from the oil. This efficiency not only includes enabling higher flow rates, but also results in a lower content of residual separation aid in the purified oil. In addition, by using the hermetic inlet, finer control can be (is) achieved over the size of droplets of the separation aid in the centrifugal separator. Therefore, the centrifugal separator and/or the operation thereof can then be optimized, for example with regard to dimensions and/or number and configuration of discs, or for example with regard to flow rate and/or rotational speed.

Taken together, methods and systems according to non-limiting aspects of the present teachings can provide the same or similar speed of separation as a general centrifugal separator, while removing the same or even higher amounts of contaminants as compared to a conventional sedimentation tank.

The oil to be purified may for example be slop oil, waste oil, slurry oil, crude oil, industrial oil, petroleum products or bio-oils. Preferably the oil is industrial oil. The oil may for example be hydraulic oil, lube oil, gear oil, engine lube oil, marine diesel oil (MDO), marine gas oil (MGO), heat transfer oil, honing oil, quenching oil, rolling oil, washing oil, synthetic gear oil, etc.

In the context of the present teachings, the term “purifying” encompasses removing at least some contaminant(s) from the oil. “Purifying” may thus encompass removing some or all contaminants from the oil. The result of purifying the oil is a purified oil, which purified oil (in line with the foregoing) has a lower content of contaminants as compared to the oil prior to purification, which oil may be termed “contaminated oil”. “Purified oil” may comprise residual contaminants but is preferably substantially free of contaminants. Here, “substantially free of contaminants” is to be understood as free of all contaminants except unavoidable impurities.

Preferably, the centrifugal separator is configured and/or operated so that the purified oil has a residual content of separation aid below 300 ppm, such as 100-300 ppm, more preferably below 100 ppm.

The contaminants may for example comprise substances such as particles, e.g. metal particles, soot particles, inorganic particles, water, acids, dissolved substances, and oil degradation products.

The steps i-iv of the method are preferably performed simultaneously. Introducing the mixture of oil and separation aid is typically performed by pumping the mixture, such as by using a screw pump, or by using gravity to introduce the mixture.

The mixture of oil and separation aid comprises (forms) a two-phase system with droplets of separation aid being dispersed within the oil. The mixture may also be considered to be a colloid or colloidal suspension.

The droplets of separation aid are formed when preparing the mixture by mixing the oil and the separation aid.

The mixer for mixing the oil, which contains contaminants, with the separation aid may comprise any suitable mixer capable of mixing the oil and the separation aid. Preferably the mixer is capable of dispersing the separation aid in the oil so as to form the droplets of separation aid in the oil. The mixer may for example comprise a paddle mixer or a static mixer.

The initial dosage (concentration) of separation aid may typically be 200 ppm to 10000 ppm, preferably 2000 ppm to 5000 ppm, based on the volume of contaminated oil.

The separation aid will absorb and/or adsorb at least some of the contaminants in the contaminated oil. The separation aid is preferably a liquid separation aid. The liquid separation aid is preferably a liquid at the temperature at which the method is carried out, such as in the temperature range of 1-150° C., typically in the range of 5-100° C., such as in the range of 5-50° C. The separation aid should be at least substantially insoluble in the contaminated oil. The separation aid should have a density higher than that of the oil, such as for example at least 5% higher, such as 10% higher, than that of the oil. Preferably the separation aid does not have a density that is more than 300% higher than that of the oil. The term “at least substantially insoluble” is to be understood as encompassing a situation in which only a minor amount, such as preferably less than 1 volume %, preferably less than 0.1 volume %, of the separation aid dissolves in the oil at a temperature of 20° C.

Due to the differing densities of the oil and the separation aid, the droplets of separation aid are separated from the oil in the centrifugal separator. If the separation aid has a higher density than the oil, it will form a lower or heavy phase together with the contaminants when subjected to gravity separation.

Preferably the separation aid has polar properties that prevents it from dissolving in the oil. The separation aid adsorbs and/or absorbs contaminants in the oil by undergoing chemical interactions, such as hydrophilic interactions, hydrophobic interactions, and charge interactions. Once adsorbed and/or absorbed, the contaminants may further increase the density of the droplets of the separation aid, thereby further improving the separation.

The separation aid for use in the present teachings may generally be constituted with the following components: a) a polar polymer; b) a hydrotrope/solubilizer; and c) a co-tenside.

Suitable separation aids having the properties described above may comprise a composition comprising a mixture of polar polymers, such as polyethylene glycols, polypropylene glycols or similar polyalkylene glycols, and/or organic surface-active components having nonionic, anionic, cationic and amphoteric properties with the ability to enhance the solubility of contaminants in the separation aid.

One example of a separation aid which can be used in the present teachings comprises: a) at least one polar polymer that is not soluble in oil and has a higher density than the oil, such as polyethylene glycol having an average molecular weight of 190-210 g/mole, e.g., Carbowax® PEG 200 (Dow Chemical Company); b) at least one surface active hydrotrope/solubilizer, such as one or more anionic sulfonic acids, phosphate ester-based substances or non-ionic surfactants from the poly-glycoside family, such as Simulsol SL 4, Simulsol SL 7 G and Simulsol AS 48 (Seppic, Air Liquide group); c) at least one amphoteric co-surfactant, such as a propionate type. e.g., Ampholak YJH-40 (Akzo Nobel) which is a sodium caprylimino dipropionate.

The hermetic inlet is configured to allow (enable) the mixture of oil and separation aid to be introduced into the separation chamber without entraining or allowing air or other gases in the atmosphere surrounding the centrifugal separator to enter the centrifugal separator and the mixture of oil and separation aid. The hermetic inlet is typically configured to introduce the mixture of oil and separation aid into and/or along the center axis of the separator bowl of the centrifugal separator. Hence the inlet zone or inlet space will be completely filled and thus have no rotating liquid level (no oil-gas/air interface), which would create low shear forces when non-rotating liquid is accelerated to the same rotational speed as the separator bowl. Typically the hermetic inlet comprises an airtight and liquid-tight connection between a rotating hollow spindle, which is attached to the separator bowl and configured to be rotatably driven by a drive unit, and a non-rotating fluid conduit leading the mixture of oil and separation aid into the centrifugal separator. The hermetic inlet may comprise one or more seals configured to provide an airtight and liquid-tight seal between the rotating spindle and the non-rotating fluid conduit. The one or more seals may comprise one or more radial or axial seals. The mixture of oil and separation aid may be introduced into the hollow spindle axially or radially. The one or more seals may be affixed to the spindle or to the fluid conduit, or may be movable, in particular rotatable, in relation to both the spindle and the fluid conduit. A lower end of the spindle may encircle and accommodate an end of a fluid conduit that leads the mixture of oil and separation aid into the centrifugal separator, or vice versa.

The hollow spindle is attached to the separator bowl, and causes the separator bowl to rotate when the hollow spindle is rotated.

The hermetic inlet is airtight and liquid-tight and prevents oxygen pickup.

The mixture of oil and separation aid is introduced into a separation chamber of the centrifugal separator. The separation chamber preferably comprises a disc stack comprising a plurality of spaced apart discs which increase the separation area within the separator bowl. The separation chamber is provided in (defined or delineated by) the separator bowl of the centrifugal separator. When the separator bowl, which is also known as a rotor, rotates, the centrifugal force acting on the mixture of oil and separation aid facilitates separation of the heavy phase and the light phase; i.e. it causes the separation aid, i.e. the droplets of separation aid, to sediment, i.e. travel, through the oil so as to be discharged as a heavy phase and thereby separated from the oil. This causes the separation aid and contaminants absorbed and/or adsorbed therein to be separated from the oil in the separation chamber. In the context of the present teachings, the terms “separated” and “separation” do not require that the separation and contaminants absorbed and/or adsorbed therein, when separated from the oil, are devoid of oil. A minor amount of oil, e.g. less than 1 vol %, preferably less than 0.1 vol % of the introduced oil, may for example be adsorb into or adsorbed onto the separation aid droplets and thus be removed from the remainder of the oil when the separation aid and contaminants absorbed and/or adsorbed therein are separated from the oil. Vice versa, a minor residual amount of separation aid, such as less than 10 vol %, preferably less than 5 vol % such as less than 2 vol % of the initially added amount of separation aid, may be present in the purified oil, for example as droplets too small to be separated by the centrifugal separator.

The centrifugal separator is preferably a high speed centrifugal separator capable of a rotation speed of at least 3000 rpm, such as up to 10000, more preferably in the interval (range) of 5000 to 9000 rpm. A suitable centrifugal separator is disclosed in EP 2496357 A1 (Alfa Laval) but other manufacturers also supply high speed separators having a hermetic inlet. The separator bowl may be driven directly by a motor, e.g. an electric motor, but may alternatively be driven by a motor via a gear or belt pulley.

The oil is discharged from the light phase outlet. Typically, the light phase outlet is fluidly connected to a central part of the separation chamber whereas the heavy phase outlet typically is fluidly connected to a peripheral part of the separation chamber.

The expression “centrifugal separator comprising a light phase outlet and a heavy phase outlet” encompasses embodiments in which the light phase outlet and the heavy phase outlet are comprised by the separation chamber.

The centrifugal separator and/or the separation chamber may further comprise a sludge outlet that is fluidly interconnectable, such as intermittently, to an outermost part of the separation chamber so as to allow larger particles to be removed from the separation chamber. The heavy phase outlet may also encompass such a sludge outlet since separation aid may also accumulate at the outermost part of the separation chamber.

The oil and the separation aid and contaminants absorbed and/or adsorbed therein may generally be discharged continuously or discontinuously. Preferably the mixture of oil and separation aid is introduced continuously through the hermetic inlet while the oil and separation aid are discharged continuously through the light phase outlet and the heavy phase outlet, respectively.

The system may further comprise one or more of:
a pump configured to pump the mixture of oil and separation aid from the mixer to the hermetic inlet,
two or more pumps configured to pump (i) oil containing contaminants and (ii) separation aid, respectively, to the mixer,
a holding tank configured to hold oil containing contaminants, and/or a holding tank configured to hold separation aid, wherein the respective tanks are fluidly connected to the mixer,
one or more fluid conduits fluidly connecting the mixer, the centrifugal separator, and where present, the holding tank,
a filter arranged upstream of the mixer for filtering the oil containing contaminants prior to the oil containing contaminants entering the mixer,
a sensor configured to measure the residual content of separation aid, and/or the residual content of contaminants, in the oil discharged from the centrifugal separator, and/or
a control unit electrically connected to the abovementioned pumps and configured to control the pumps to control the flowrate of the mixture of oil and separation aid from the mixer to the hermetic inlet,
   the control unit preferably further being configured to control the dosing of separation aid, i.e. control the amount thereof supplied, to the mixer,
      the control unit preferably further being connected to the abovementioned sensor, the control unit further being configured to control the dosing of the separation aid based on measurements of the residual content of separation aid, and/or the residual content of contaminants.

In such a method and system, preferably at least one of the light phase outlet and the heavy phase outlet is a hermetic outlet. Such an embodiment is advantageous in that it further prevents air and other gases from entering the separator and/or mixing with the oil and/or separation aid, thereby reducing shear forces on the discharged oil and separation aid. This also prevents foaming in or at the outlet. Preferably, the centrifugal separator comprises a hermetic outlet pumping device, such as a pump wheel, e.g. an impeller, rotating with the separator bowl for reducing shear forces. Preferably at least the outlet through which the oil is discharged is a hermetic outlet. Similar to a hermetic inlet, a hermetic outlet is configured to discharge the oil or the separation aid, as the case may be, without exposing the oil or separation aid to air and with reduced shear forces.

In such a method and system, the centrifugal separator is preferably a hermetic separator. This further decreases the risk of air and other atmospheric gases from entering the centrifugal separator and/or the mixture of oil and separation aid. A hermetic separator has a hermetic inlet and hermetic outlets. The hermetic separator is further configured, owing to the inclusion of the hermetic inlet and hermetic outlets, to minimize or substantially eliminate oil-air interfaces inside the separator, thereby reducing shear forces.

Preferably the method further comprises:
v. forming the mixture of the oil and the separation aid by mixing the oil and the separation aid in a mixer, preferably a static mixer.

Conversely, the mixer comprised by the system is preferably a static mixer.

Step v is preferably performed before steps i-iv or simultaneously with steps i-iv.

This is advantageous in that a static mixer allows the mixing of oil and separation aid to be controlled precisely. This, inter alia, allows the size of the droplets of separation aid to be controlled. By controlling the size of the droplets, the construction and operation of the centrifugal separator can be optimized so as to efficiently separate the droplets from the oil.

Preferably the mixer is a static inline mixer. Other types of mixers which can be used are, for example, laminar and turbulent static mixers, a mixing pump or a pipe restriction (constriction) that creates a pressure drop.

The size of the droplets may be controlled by controlling the pressure difference over (in the headspace of) the mixer. A higher pressure difference yields smaller droplets and vice versa. The pressure difference may be controlled by controlling the pressure of the oil and separation aid entering the mixer and by also controlling the pressure of the mixture of oil and separation aid exiting the mixer. This may for example be achieved by controlling the flowrate of pumps connected to deliver the oil and separation aid, respectively, to the mixer. Here, a lower flow rate generally leads to a lower pressure difference.

Generally the mixer should be constructed and/or operated so that the smallest droplets formed from the separation aid are larger than the size limit below which the centrifugal separator is unable to separate all droplets of separation aid from the oil. This size limit depends on the flowrate, but is typically for a typical centrifugal separator about 5 μm at 0.15 m³/h, about 6.5 μm at 0.25 m³/h, and about 9 μm at 0.5 m³/h. The size limit is further dependent on the density difference between the heavy phase and the light phase as well as on the oil viscosity. By adjusting the droplet size of the separation aid by adjusting the pressure difference over the mixer, the method and system may be used for purifying oil of different viscosities. Specifically, as the viscosity increases, the size limit for complete separation of droplets also increases. As an example, a centrifugal separator may have a size limit of about 4 μm at flow rate of 4500 l/h and an oil viscosity of 10 cSt. At a viscosity of 25 cSt the size limit is approximately 6.5 μm, and at a viscosity of 50 cSt the size limit is about 9.5 μm for that specific centrifugal separator.

The mixer is thus advantageously constructed and/or operated so that the droplets formed from the separation aid are at least 5 μm, such as at least 6.5 μm, preferably at least 9 μm.

On the other hand, the mixer should be constructed and/or operated so that the droplets formed from the separation aid are sufficiently small and thus numerous, so as to provide a high interface area between the oil and the separation aid so that the separation aid droplets may efficiently adsorb and/or absorb the contaminants in the oil. The mixer is thus advantageously constructed and/or operated so that the droplets formed from the separation aid are at less than 50 μm, such as less than 20 μm, preferably less than 10 μm.

Preferably, the mixer is thus advantageously constructed and/or operated so that the droplets formed from the separation aid are in the interval (range) of 5 μm to 50 μm.

Optimally the mixer is constructed and/or operated so that the droplets formed from the separation aid are equal in size to, or slightly larger than, such as 0.5-2 μm larger, the size limit for complete separation for the centrifugal separator and flow rate used.

In order to increase mixing capacity, one or more additional mixers may be added in parallel to the mixer so that the oil and separation aid are mixed in parallel mixers. This enables an increasing of the throughput of oil and separation aid without corresponding increases in pressure differences.

Preferably the method further comprises:
vi. obtaining a measurement of the residual content of separation aid and/or the residual content of contaminants in the oil discharged from the separation chamber, and
vii. adjusting the size of droplets of the separation aid in the mixture of oil and separation aid based on the measurement.

Steps vi and vii are preferably performed sequentially or simultaneously, and preferably simultaneously with steps i-iv.

Conversely, the control unit discussed above may be configured to receive or retrieve measurements of the residual content of separation aid, and/or the residual content of contaminants, in the oil discharged from the centrifugal separator, and based on such measurements, control the pumps that pump (i) the oil containing contaminants and (ii) the separation aid, respectively, to the mixer so as to vary the droplet size in order to maintain a droplet size above the size limit of the centrifugal separator at the flow rate used. The control unit discussed above may further be configured to, based on such measurements, control the flowrate of the mixture of oil and separation aid from the mixer to the hermetic inlet so as to lower the flow rate, and thereby lower the size limit of the centrifugal separator, if needed to obtain a desired residual content of separation aid, and/or a desired residual content of contaminants in the oil discharged from the centrifugal separator. Additionally, the dosage, i.e. content, of separation aid in the mixture of oil and separation aid may be adjusted based on the measurement.

In particular, the system may further comprise:
a sensor configured to measure the residual content of separation aid, and/or the residual content of contaminants, in the oil discharged from the centrifugal separator,
a control unit connected to the sensor and configured to obtain from the sensor the measurement of the residual content of separation aid, and/or the residual content of contaminants, in the oil discharged from the centrifugal separator, and
a pump configured to control the dosing (supply) of the separation aid to (into) the mixer,

wherein the control unit is further configured to adjust the dosing of the separation aid to the mixer, and/or the size of droplets of separation aid formed in the mixer, by controlling at least the pump based on the measurement of the residual content of separation aid, and/or the residual content of contaminants, in the oil discharged from the centrifugal separator.

Such an embodiment of the present teachings is advantageous in that it enables an optimization of the droplet size for efficient adsorption and/or absorption of contaminants and efficient separation of the separation aid from the oil. This also generally allows different oils, such as oils of different viscosities and/or chemical constitution, to be purified in that an increased or significant residual content of separation aid and/or contaminants indicate that the mixing, and hence the droplet size of the separation aid, needs to be adjusted. The control unit may in particular be configured to control the pump that controls the dosing (supply) of the separation aid to the mixer, and or control a pump that delivers oil containing contaminants to the mixer, so as to control the pressure drop over the mixer and thereby control the size of droplets of separation aid formed in the mixer.

To further account for oils of differing viscosities, the method and system may further comprise obtaining a measurement, by using a sensor configured for obtain the measurement, of the viscosity of the oil containing contaminants, and the control unit may be configured to adjust the droplet size of the separation aid by controlling at least the pump based on the measured viscosity.

This is advantageous in that it further enables purification of oils having different viscosities.

The method may further comprise:
viii. allowing the mixture of the oil and the separation aid to react (interact) in a holding tank prior to introducing the mixture of the oil and the separation aid into the separation chamber.

Conversely, the system may further comprise:
a holding tank fluidly connected for receiving and holding the mixture of the oil and the separation aid from the mixer prior to introduction of the mixture of the oil and the separation aid into the separation chamber.

Step viii is preferably performed before steps i-iv or simultaneously with steps i-iv.

Such an embodiment is advantageous in that it allows more time for the separation aid to react (interact), i.e. absorb and/or adsorb contaminants in the oil. It further lowers the separation load on the centrifugal separator by allowing some of the separation aid and contaminants adsorbed or absorbed therein to be separated, by sedimentation or floatation, in the holding tank. For example, some of the larger particles present as contaminants in the oil may be separated from the oil already in the holding tank. Such larger particles may, or may not, be adsorbed or absorbed by the separation aid. This further allows for an even more uniform distribution of droplet sizes and thereby enables further optimization of the configuration and operation of the centrifugal separator. Additionally, droplets may coalesce in the holding tank and thus increase the separation efficiency of the centrifugal separator.

The mixture of the oil and the separation aid may be allowed to react (interact) for different amounts of time. The retention time may thus in some cases be short, i.e. the mixture of oil and separation aid is continuously pumped into and discharged out of the holding tank. In other cases the retention time is longer, such as when the method and system are operated as a batch process and a mixture of oil and separation aid is introduced into the holding tank and held there for a prescribed time period.

As a further advantage, this provides further time for the separation aid to adsorb and/or absorb the contaminants in the oil, thereby increasing the efficiency of the use of the separation aid.

A further aspect of the present teachings concerns a computer program product containing instructions which, when carried out by a processor of the control unit described above, causes the system to perform the method of adjusting the dosing of the separation aid and/or the droplet size thereof as described above.

### BRIEF DESCRIPTION OF THE DRAWINGS

A more complete understanding of the abovementioned and other features and advantages of the present invention will be apparent from the following detailed description of preferred embodiments in conjunction with the appended schematic drawings, wherein:

FIG. 1A shows a first embodiment of a system according to one aspect of the present teachings.

FIG. 1B shows, in closer detail, the centrifugal separator shown in FIG. 1B.

FIG. 2 is a flowsheet showing a representative embodiment of a separation method according to the present teachings.

### DETAILED DESCRIPTION OF THE INVENTION

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

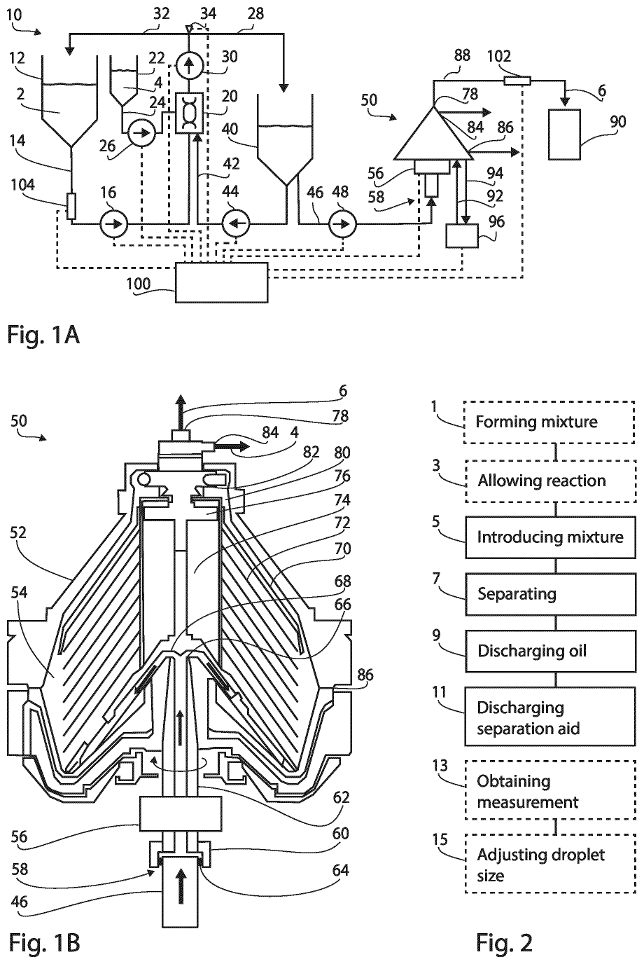

FIG. 1A shows a first embodiment of a system 10 according to a representative embodiment of the present teachings. The system 10 comprises a first holding tank 12 for holding oil 2 comprising contaminants. The oil 2 is pumped via a fluid conduit 14 connected to the first holding tank 12 by a pump 16 to a mixer 20. The mixer 20 is preferably, and as shown in FIG. 1, implemented as a static mixer. A second holding tank 22 holds a separation aid 4 which is pumped into the mixer 20 via a fluid conduit 24 by a pump 26.

In the mixer 20 the oil 2 and the separation aid 4 are mixed resulting in a mixture of oil 2 and separation aid 4. More particularly, the mixing causes the formation of a plurality of droplets of separation aid 4 in the oil 2. The droplets, due to the chemical and physical properties of the separation aid, and due to the large interface area between oil 2 and separation aid 4 formed by the plurality of droplets, efficiently absorb and/or adsorb contaminants in the oil 2. The mixture of oil 2 and separation aid 4 is then led through a fluid conduit 28 to a third holding tank 40 via another pump 30. A portion of the mixture of oil 2 and separation aid 4 may be recirculated to the first holding tank 12 via a fluid conduit 32 controlled by a valve 34. Recirculating part of the mixture of oil 2 and separation aid 4 provides further time for the separation aid to absorb and/or adsorb contaminants, and also allows for controlling the filling level of the second holding tank 22 in case a lower flow rate of mixture of oil 2 and separation aid 4 is desired in the later stages of the system as further discussed below.

In the third holding tank 40, the mixture of oil 2 and separation aid 4 may be held for a period of time. During this period of time the separation aid may react, i.e. absorb and/or adsorb further contaminants in the oil 2. Additionally or alternatively, any large debris in the oil 2, or any larger droplets of separation aid 4, may sediment in, or float to the surface of, the mixture of oil 2 and separation aid 4 so as to be easily removable from the bottom of the third holding tank 40 or be skimmed from the surface of the mixture of oil 2 and separation aid 4. Advantageously, the sedimented separation aid may be reused by being pumped from the second holding tank 40 to the mixer 20 using a fluid conduit 42 and a pump 44.

A further fluid conduit 46 allows the mixture of oil 2 and separation aid 4 to be pumped by a pump 48 into a centrifugal separator 50. The centrifugal separator is shown in more detail in FIG. 1B. Specifically, the centrifugal separator 50 comprises a separator bowl 52 defining a separator chamber 54 that is arranged (configured) to be rotated by a motor 56. The mixture of oil 2 and separation aid 4 is led, as indicated by the arrow, through the fluid conduit 46 (shown enlarged in FIG. 1B) into an hermetic inlet 58 formed by a lower end (inlet port) 60 of a hollow spindle 62 that extends between the motor 56 and the separator bowl 52, the hermetic inlet 58 comprising a rotating seal 64 that provides an airtight and liquid-tight seal between the lower end 60 of the rotating spindle 62 (as indicated by the curved arrow extending from reference number 58) and the non-rotating fluid conduit 46.

The seal 64 as shown in FIG. 1B rotates with the lower end 60 of the spindle 62, e.g. by being affixed to the lower end 60. However, as long as an airtight and liquid-tight connection is provided, other configurations are possible such as an embodiment in which the seal 64 is affixed to the fluid conduit 46 and thus does not rotate with the spindle. FIG. 1B further shows the lower end (inlet port) 60 of the spindle 62 having an enlarged inner diameter for housing (receiving, holding) the seal 64 and accommodating the upper end of the fluid conduit 46. However, as long as an airtight and liquid-tight connection is provided, other configurations are possible such as an embodiment in which the end of the fluid conduit 46 has an enlarged diameter for holding the seal 64 and accommodating the lower end 60 of the spindle 62. FIG. 1B further shows the seal 64 as being a radial seal. However, as long as an airtight and liquid-tight connection is provided, the seal 64 may be provided, e.g., as an axial seal, i.e. positioned between the axial ends of the fluid conduit 46 and the lower end 60 of the spindle 62. Further, although one seal 64 is shown in FIG. 1B, other configurations, such as two or more seals, for example with one seal affixed to the lower end 60 of the spindle 62 and with one seal affixed to the end of the fluid conduit 46, are possible as long as an airtight and liquid-tight connection is provided between the fluid conduit 46 and the lower end 60 of the spindle 62. The seal 64 further does not need to rotate with the lower end 60 of the spindle 62, or the end of the fluid conduit 46, but can instead slip relative to both the lower end 60 and the end of the fluid conduit 46. Such a configuration may be obtained by using a seal 64 that is not affixed to either the lower end 60 of the spindle 62 or to the end of the fluid conduit 46.

Further, whereas FIG. 1B shows that the mixture of oil 2 and separation aid 4 introduced into the lower end 60 of the spindle 62 in an axial direction, it is further possible to provide the spindle 62 with at least one radial hole (not shown) extending radially from the hollow interior of the spindle 62 to the outer surface thereof, and to provide a non-rotating annular or toroid shell (not shown) around that part of the spindle 62 to define, together with the outer surface of the spindle 62 and seals (not shown), an annular or toroid chamber, the chamber being connected to the fluid conduit such that the fluid conduit 46 introduces the mixture of oil 2 and separation aid 4 into the annular or toroid chamber from where it enters the spindle 62 through the radial hole.

The mixture of oil 2 and separation aid 4 thus enters the centrifugal separator 50 from (through, via) the bottom thereof through the hermetic inlet 58 so as to rise through the hollow spindle pipe 62 from the lower end 60, which has the seal 64, to an upper end 66 of the hollow spindle pipe 62, at which point a distributor 68 accelerates the mixture of oil 2 and separation aid 4 and causes it to flow radially outward through a disc stack 70 comprising a plurality of separator discs 72 where the droplets of the separation aid 4 are separated from the oil 2.

In use, due to the hermetic inlet 58, the inlet space, i.e. the volume extending from the lower end 60 of the spindle 62 to its upper end 66 and the distributor 68 is thus completely filled with the mixture of oil 2 and separation aid 4. The oil 2 then moves towards the center 74 of the separator bowl 52 from where it is pumped out by an impeller 76 though a light phase outlet 78 as purified oil 6. The separated heavier droplets of the separation aid 4 are collected by moving towards the outer upper parts 80 of the separator bowl 52, where the separation aid 4 is pumped by an impeller 82 and ejected through a heavy phase outlet 84. Solid contaminants may further be ejected though one or more solid ports 86 located at the periphery of the separator bowl 52.

The light phase outlet 78 and the heavy phase outlet 84 may be configured as open outlets. In such an embodiment, a non-rotating pump wheel or paring disc may be used for pumping out the purified oil and the separation aid. Alternatively the outlets may be configured as hermetic outlets, by further providing an airtight and liquid-tight connection to the fluid conduits that respectively lead the purified oil 6 and the separation aid and contaminants from (out of) the centrifugal separator 50.

Returning to FIG. 1A, it can be seen that the purified oil may led though a fluid conduit 88 and be collected in a tank 90. Further, the centrifugal separator is provided with operation water to operate the solid port(s) 86, via a supply conduit 92 and a return conduit 94 fluidly connected to a water unit 96 configured to selectively provide water to the centrifugal separator 50. The operation water may also cool the hermetic inlet 58, in particular the seal 64, the separator bowl 52, and/or the motor 56.

A control unit 100 may further be provided in the system 10. The control unit 100 is, as shown in dashed lines electrically connected to the pumps 16, 26, 30, 44, and 48, to the valve 34, to the motor 56 of the centrifugal separator 50, and finally to the water unit 96. The control unit 100 may further be electrically connected to a sensor 102 configured to measure an amount of residual separation aid 4 and/or an amount of residual contaminants in the purified oil 6. Specifically, the control unit 100 may be configured to control the operation of the system 10 to ensure a desired level of purification of the oil.

Thus, if the sensor 102 detects an undesirably high content of separation aid 4 and/or contaminants in the purified oil 6, the control unit 100 may be configured to reduce said content by one or more of:
adjusting, in particular increasing, the dosing (amount) of separation aid 4 supplied into the mixer 20 by controlling one or both of the pumps 16 or 26 in response to a measurement of the amount of residual separation aid 4 and/or the amount of residual contaminants in the purified oil 6 obtained by the sensor 102,
adjusting, in particular increasing, the amount of the mixture of oil 2 and separation aid 4 that is recirculated to the holding tank 12 by controlling the valve 34,
adjusting, in particular increasing, the size of the droplets of the separation aid 4 formed in the mixer 20 by decreasing the pressure difference over (in the headspace of) the mixer 20, by controlling the pumps 16 and 26,
adjusting, in particular lowering, the flow rate of the mixture of the oil 2 and the separation aid 4 into the centrifugal separator 50 by controlling the pump 48,
adjusting, in particular increasing or decreasing, the rotational speed of the separator bowl 52 of the centrifugal separator 50, and/or
discharging solids through the solid ports 86 by controlling the water unit 96.

Additionally, a viscosity sensor 104 may be provided in the fluid conduit 14 for measuring the viscosity of the oil 2. Thus the control unit 100 may further be configured to adjust the droplet size of the separation aid 4 in the mixer 20 by controlling the pressure difference over (in the headspace of) the mixer 20, by controlling the pumps 16, 26 and 30, so as to compensate for the change in separation size limit caused by different oil viscosities. The viscosity sensor 104 may alternatively be provided in (at) any position along the fluid conduits before the centrifugal separator 50 or in or after the light phase outlet 76.

Referring to FIG. 1A, it should be noted that the holding tank 40 may be dispensed with (omitted) such that the flow conduit 28 is directly connected to the flow conduit 46. In such an embodiment, the pump 48 may be removed (omitted). Further, the pump 30 may be dispensed with (omitted), provided that the combined pressure of the oil and the separation aid in the mixer 20 is sufficient to deliver the mixture to the holding tank 40 or directly to the centrifugal separator 50.

Further, whereas FIG. 1A shows a number of pumps, i.e. pumps 16, 26, 30, 44, and 48, one or more of these pumps, or all, may be dispensed with (omitted) depending on the fluid pressure at each pump's position. As an example, the pump 16 may for example be dispensed with (omitted) if the hydrostatic pressure at the mixer 20, due to the vertical position of the holding tank 12 relative to the mixer, is sufficient to introduce the oil 2 into and through the mixer.

Likewise, the pump 26 may be dispensed with (omitted) if the pressure of the separation aid in the flow conduit 24 at the entrance to the pump 20 is sufficient, e.g. due to the vertical positioning of the holding tank 22 or the pressure within the holding tank 22, to introduce the separation aid 4 and mix it with the oil 2.

Also pump 30 may be dispensed with (omitted) if the pressure of the mixture of oil 2 and separation aid 4 exiting the mixer 20 is sufficient to deliver the mixture to the holding tank 40 or directly into the centrifugal separator 50, in which latter case the pump 48 may be dispensed with (omitted).

Additionally, the flow conduits 32 and 42, as well as the pump 44, are optional.

Although FIG. 1B shows the general construction of a suitable type of centrifugal separator having a hermetic inlet, other types of centrifugal separators having hermetic inlets may be equally suitable to use in the system 10 and in the method according to the present teachings. It should in particular be noted that different constructions of the light and heavy phase outlets are possible. Further, in FIG. 1B the light phase outlet 78 and the heavy phase outlet 84 are depicted as open outlets in that no airtight and liquid-tight connections between the outlets and fluid conduits are shown; however, hermetic light and heavy phase outlets may instead be used.

FIG. 2 is a flowsheet showing a first embodiment of a representative method according to the present teachings. The following steps are shown:

In a first optional step denoted with reference numeral 1, a mixture of oil comprising contaminants and separation aid is formed by mixing the oil and the separation aid in a static mixer.

In a second optional step denoted with reference numeral 3, the mixture of the oil and the separation aid is allowed to react (interact) in a holding tank prior to introducing the mixture of the oil and the separation aid into the separation chamber of the centrifugal separator.

In a first main step denoted with reference numeral 5, the mixture of the oil and the separation aid, wherein the density of the separation aid is higher than that of the oil, is introduced through a hermetic inlet into a separation chamber of a rotating separator bowl of a centrifugal separator.

In a second main step denoted with reference numeral 7, the separation aid and contaminants absorbed and/or adsorbed therein are separated from the oil in the separation chamber.

In a third main step denoted with reference numeral 9, the oil is discharged from a light phase outlet of the separation chamber.

In a fourth main step denoted with reference numeral 11, the separation aid and contaminants absorbed and/or adsorbed therein are discharged from a heavy phase outlet of the separation chamber.

In a further optional step denoted with reference numeral 13, a measurement of the residual content of separation aid and/or the residual content of contaminants in the oil discharged from the separation chamber is obtained.

In yet a further optional step denoted with reference numeral 15, the size of droplets of separation aid in the mixture of the oil and separation aid is adjusted based on the measurement of the residual content of separation aid and/or the residual content of contaminants in the oil discharged from the separation chamber. As a separate step, or as part of this step, the size of droplets of separation aid in the mixture of the oil and separation aid is adjusted based on a measurement of the oil.

### Example 1. Comparison Between (a) the Method and System According to the Present Teachings and (b) the (Conventional) Use of a Settling Tank

Oil having a viscosity of 57.6 cST and a temperature of 20° C. was purified according to the present teachings or according to a conventional settling (sedimentation) method.

Specifically, a setup as shown in FIG. 1 was used with an Alfa Laval hermetic centrifugal separator. 2000 ppm and 5000 ppm dosages of booster (separation aid) was used. The residual content of separation aid was measured according to ISO 4406, and the separation aid concentration was measured using FTIR analysis, and inlet and outlet of the centrifugal separator.

The results were compared to the same oil treated according to a conventional settling method, i.e. where the oil, after mixing with the same dosage of separation aid, was allowed to settle in a holding tank and then filtrated. More specifically, in the conventional settling method, a residual separation aid content of 100-300 ppm in the purified oil was obtained.

The results obtained after using the method and system according to the present teachings as described above for 5 and 9 minutes, respectively, yielded the results shown in Table 1 below:

TABLE 1

| Flow | Dosage 2000 | Dosage 2000 | Dosage 5000 | Dosage 5000 |
|---|---|---|---|---|
| rate | ppm / 5 min | ppm / 9 min | ppm / 5 min | ppm / 9 min |
| [L/h] | Residual content | | | |
| 150 | 35 ppm | 72 ppm | Not measured | Not measured |
| 500 | 50 ppm | 62 ppm | 155 ppm | 151 ppm |
| 1000 | 119 ppm | 249 ppm | 263 ppm | 204 ppm |

As can be seen in Table 1, the residual content of the separation aid is lower or similar to the residual content obtained in the conventional settling method over a wide range of useable flow rates, i.e., at least up to and including 1000 liters per hour. Better results were found at the lower flow rates. A good balance between flowrate and residual concentration of separation aid was found at the flowrates 500 and 750 liters/h.

The tests further examined the potential of removing the holding tank 40. Results showed that the holding 40 could be omitted when the lower flowrates of 350 and 500 liter/h were used without any significant increase in the residual separation aid content in the purified oil.

1. A method for purifying an oil containing contaminants, the method comprising:
i. introducing a mixture of the oil and a separation aid through a hermetic inlet of a centrifugal separator and into a separation chamber of a rotating separator bowl of the centrifugal separator, the hermetic inlet sealing off an inlet port of the centrifugal separator so that no atmospheric gases are introduced and mixed into the mixture via the input port while the mixture is being fed from a fluid conduit into the centrifugal separator, the separation aid having a density higher than the density of the oil,
ii. separating the separation aid and contaminants absorbed and/or adsorbed in the separation aid from the oil in the separation chamber,
iii. discharging oil from a light phase outlet of the separation chamber, and
iv. discharging separation aid having contaminants absorbed and/or adsorbed therein from a heavy phase outlet of the separation chamber,
wherein the separation aid:
is a liquid at the temperature at which the method is being performed,
is polar and at least substantially insoluble in the oil, thereby forming a two-phase mixture with the oil upon mixing with the oil, and
chemical interacts with contaminants in the oil and thereby adsorbs and/or absorbs contaminants in the oil.

2. The method according to claim 1, wherein at least one of the light phase outlet and the heavy phase outlet is a hermetic outlet.

3. The method according to claim 1, wherein the centrifugal separator is a hermetic separator.

4. The method according to claim 1, further comprising:
v. forming the two-phase mixture of the oil and the separation aid by mixing the oil and the separation aid in a mixer.

5. The method according to claim 4, further comprising:
vi. obtaining a measurement of the residual content of separation aid and/or the residual content of contaminants in the oil discharged from the separation chamber, and
vii. adjusting the size of droplets of separation aid in the mixture based on the measurement by controlling a pressure difference in a headspace of the mixer.

6. The method according to claim 1, further comprising:
viii. supplying the two-phase mixture to a holding tank prior to introducing the two-phase mixture into the separation chamber so that the oil and the separation aid interact in the holding tank prior to being separated in the centrifugal separator.

7. A system for purifying an oil containing contaminants, comprising:
a tank containing a separation aid that (i) is a liquid at the temperature at which an oil purification process will be carried out, (ii) is polar and at least substantially insoluble in the oil, thereby forming a two-phase mixture with the oil upon mixing with the oil, and (iii) chemical interacts with contaminants in the oil and thereby adsorbs and/or absorbs contaminants in the oil,
a mixer configured to mix the oil with the separation aid supplied from the tank to produce a two-phase mixture of the oil and the separation aid,
a centrifugal separator having a separator bowl comprising a separation chamber configured to separate the separation aid having contaminants absorbed and/or adsorbed therein from the oil, the centrifugal separator further comprising a light phase outlet and a heavy phase outlet,
wherein the centrifugal separator further comprises a hermetic inlet at an inlet port of the centrifugal separator where the two-phase mixture is introduced into the separation chamber, the hermetic inlet sealing the inlet port so that no atmospheric gases are mixed into the two-phase mixture while the two-phase mixture is being introduced into the centrifugal separator.

8. The system according to claim 7, further comprising:
a sensor configured to measure the residual content of separation aid, and/or the residual content of contaminants, in the oil discharged from the light phase output of the centrifugal separator,
a control unit electrically connected to the sensor and configured to obtain a measurement of the residual content of separation aid, and/or the residual content of contaminants, in the oil discharged from the centrifugal separator,
a pump configured to control the amount of the separation aid supplied to the mixer (20),
wherein the control unit is further configured to adjust the amount of the separation aid supplied to the mixer, and/or the size of droplets of separation aid formed in the mixer, by controlling at least the pump based on the measurement of the residual content of separation aid, and/or the residual content of contaminants, in the oil discharged from the light phase output of the centrifugal separator.

9. The system according to claim 8, further comprising:
a holding tank fluidly interconnected between the mixer and the centrifugal separator, the holding tank being configured to hold the two-phase mixture supplied from the mixer prior to introduction of the two-phase mixture into the separation chamber.

10. A non-transient computer-readable medium having instructions stored thereon which, when executed by a processor of a control unit of an oil purification system, causes the oil purification system to perform the method according to claim 5.

11. The method according to claim 4, wherein the mixer is a static mixer.

12. The method according to claim 1, wherein the centrifugal separator is an air-tight separator.

13. The method according to claim 1, wherein:
the hermetic inlet is disposed a lower end of a hollow spindle defining the inlet port into the separation chamber,
an end of the fluid conduit is disposed in the interior of the inlet port, and
a seal hermetically seals a junction of the hermetic inlet and the end of the fluid conduit such that the junction is air-tight and liquid-tight.

14. The method according to claim 13, wherein during the performance of the method:
the end of the fluid conduit is stationary, and
the hermetic inlet is rotating.

15. The method according to claim 14, wherein during the performance of the method the seal rotates with the hermetic inlet.

16. The method according to claim 15, wherein the seal is a radial seal disposed on an inner circumferential surface of the hermetic inlet and slidably contacts an outer circumferential surface of the end of the fluid conduit.

17. The method according to claim 16, wherein the hermetic inlet is disposed lower than the light phase outlet and the heavy phase outlet.

18. The method according to claim 17, wherein the method is performed continuously such that the two-phase mixture is being introduced into the separation chamber while purified oil is simultaneously being discharged via the light phase outlet and separation aid containing contaminants removed from the oil is simultaneously being discharged via the heavy phase outlet.

19. The method according to claim 18, wherein the heavy phase outlet and the light phase outlet are air-tight outlets such that the centrifugal separator is an air-tight separator.

20. The method according to claim 19, further comprising:
measuring an amount of residual content of contaminants in the oil being discharged from the light phase outlet, and
adjusting the size of droplets of separation aid in the two-phase mixture based on the measurement by adjusting the pressure in a headspace of the mixer.
